(19) United States
(12) Patent Application Publication
(10) Pub. No.: US 2016/0012559 A1
(43) Pub. Date: Jan. 14, 2016

(54) CAREER RECOGNITION AND DEVELOPMENT

(71) Applicants: Jim PATTERSON, Ewa Beach, HI (US); Jack PATTERSON, Ewa Beach, HI (US); Gan Chia HUEY, Singapore (SG); Julian Thierry Claude Lucien GRIMAULT, Singapore (SG); Emmanuel RIVERA, Austin, TX (US)

(72) Inventors: Jim Patterson, Ewa Beach, HI (US); Jack Patterson, Ewa Beach, HI (US); Gan Chia Huey, Singapore (MY); Grimault Julian Thierry Claude Lucien, Singapore (SG); Emmanuel Rivera, Austin, TX (US)

(21) Appl. No.: 14/768,176

(22) PCT Filed: Feb. 14, 2014
(86) PCT No.: PCT/US14/16554

§ 371 Date: Aug. 14, 2015

Related U.S. Application Data
(60) Provisional application No. 61/764,944, filed on Feb. 14, 2013.
(60) Provisional application No. 61/891,898, filed on Oct. 17, 2013.
(60) Provisional application No. 61/891,897, filed on Oct. 17, 2013.

(51) Int. Cl. G06Q 50/20; G06Q 50/00; G06F 17/30

(52) U.S. Cl. CPC G06Q 50/2057; G06F 17/30867; G06Q 50/01

(57) ABSTRACT

Implementations described herein include gathering through a website, data from posters/experts in particular careers through computing devices. The data is presented to a number of users looking at different careers and jobs. In one implementation, if information in a user's profile matches one or more attributes associated with a career, the career is recommended to the user. In another possible implementation, results of a third party personality test can be used to augment the user's profile. In yet another possible implementation, various webpages and/or services can be examined for user activity, and this activity can be used to augment or further quantify the user's profile.

### RELATED APPLICATIONS

This application claims the benefit of and priority to U.S. Provisional application Ser. No. 61/764,944 entitled “Methods and Systems for Career Building” filed Feb. 14, 2013; U.S. Provisional Application Ser. No. 61/891,898 entitled “Methods and Systems for Career Placement” filed Oct. 17, 2013; and U.S. Provisional Application Ser. No. 61/891,897 entitled “Career Aptitude Assessment” filed Feb. 17, 2013, all of which are incorporated by reference herein.

### BACKGROUND

Work and careers are an integral part of people's lives. However, finding a meaningful job can be very challenging. Many people begin searching for careers early in life, only to search again during their midlife and later years. Some people have the luxury of relatives with broad perspectives to shepherd them through the various jobs and careers on offer; however most stumble through life with very little idea of the possible career paths that exist. As a result, many people get stuck in jobs/careers for which they are ill-suited and which provide inadequate satisfaction.

### SUMMARY

Implementations and example embodiments are described herein. In one example embodiment, a user is provided with one or more recommendations for enjoyable careers that the user has an aptitude for, and which can provide a salary meeting the user's needs.

This summary is provided to introduce concepts that are further described below in the detailed description. This summary is not intended to identify key or essential features of the claimed subject matter, nor is it intended to be used as an aid in determining a scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates an example computing device.

FIG. 2 illustrates an example system.

FIG. 3 illustrates an example webpage.

FIG. 4 illustrates an example method.

FIG. 5 illustrates an example method.

FIG. 6 illustrates an example method.

### DETAILED DESCRIPTION

Architectures, platforms and methods are described herein which provide for career recognition and development and which allow individuals to find careers for which they are well-suited. People can achieve career satisfaction by finding a career at their “golden triple point”, i.e. a career that they 1) enjoy, 2) have a natural ability for, and 3) which provides an adequate salary/compensation. Finding such a career can satisfy not only the individual worker, but also employers and society as a whole. Many people miss the golden triple point by focusing on items 2 and 3 above while partially or entirely ignoring item 1.

In one implementation, career information from a plurality of posters is accessed, such as though, for example, crowdsourcing, and the information is organized into various careers. In this way users can browse information regarding a range of careers from many different viewpoints and perspectives.

In another possible implementation, information is accessed regarding the personality, education, skills, competencies, etc., of the user to create a user profile. This can include collecting information from the user himself and/or collecting information by crawling various webpages and other information sources for data associated with the user.

The user's profile can then be compared against information associated with a variety of careers to look for correlations and suggest possible career choices for which the user might be well-suited.

### Example Environment

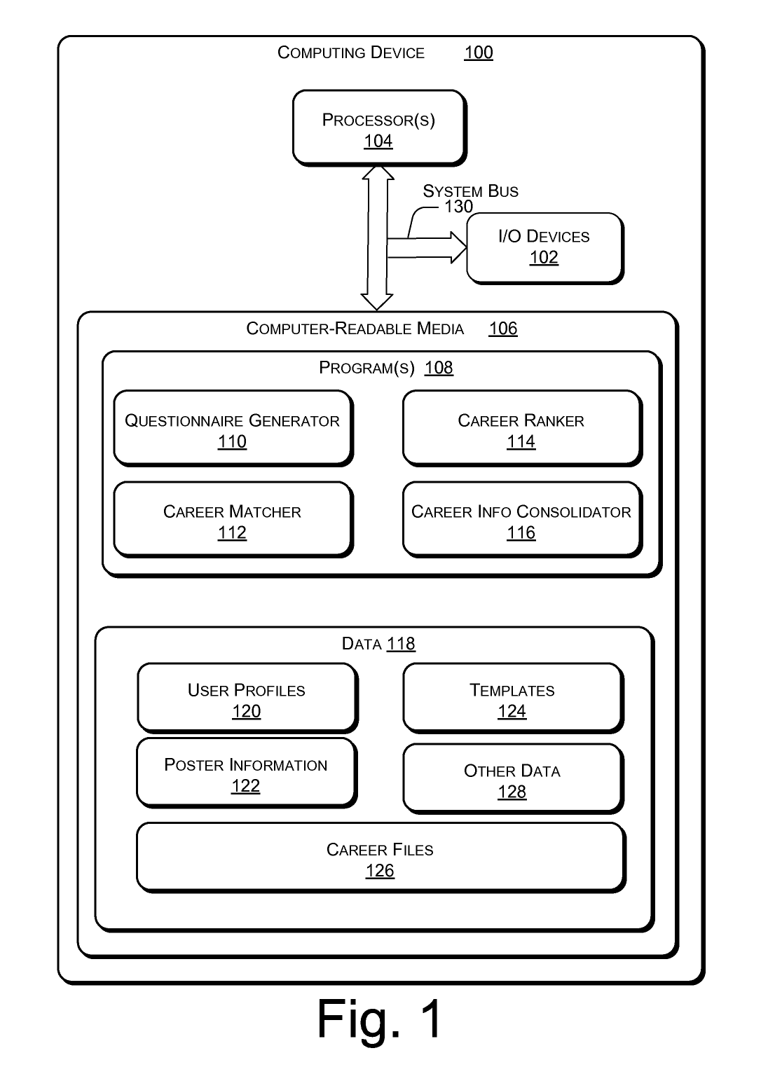

FIG. 1 shows an example computing device 100 suitable for implementing embodiments of career recognition and development. Computing device 100 can be implemented as any form of computing and/or electronic device. For example, computing device 100 can include a server, a desktop PC, a notebook (or other portable computer, such as a tablet, smartphone, etc.), a workstation, a mainframe computer, an Internet appliance and so on. Computing device 100 can include input/output (I/O) devices 102, one or more processor(s) 104, and computer-readable media 106.

I/O devices 102 can include any device over which data and/or instructions can be transmitted or received by computing device 100. For example, I/O devices 102 can include one or more of an optical disk drive, a USB device, a keyboard, a touch screen, a monitor, a mouse, a digitizer, a scanner, a track ball, etc.

I/O devices 102 can also include one or more communication interface(s) implemented as any of one or more of a serial and/or parallel interface, a wireless interface, any type of network interface, a modem, a network interface card, or any other type of communication interface capable of connecting computing device 100 to a network or to another computing or electrical device.

Processor(s) 104 include microprocessors, controllers, graphic processing unit(s) and the like configured to process various computer executable instructions controlling the operation of computing device 100. For example, processor(s) 104 can enable computing device 100 to communicate with other electronic and computing devices, and to process instructions and data in conjunction with programs 108 stored in computer-readable media 106.

Computer-readable media 106, can include one or more memory components including random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like. All or part of computer-readable media 106 can exist on various devices. For example, parts of computer-readable media 106 may exist in cloud storage or on other computing devices and be accessed by computing device 100 as needed.

Computer-readable media 106 provides storage mechanisms to store various information and/or data such as software applications and any other types of information and data related to operational aspects of computing device 100. Programs 108 stored on computer-readable media 106 can include, for example, a questionnaire generator 110, such as an application allowing for the creation, modification, and/or manipulation of questions to be asked to users and posters visiting a career development website. Programs 108 can also include a career matcher 112 configured to compare a user's profile to a variety of available careers and attempt to find careers for which the user might be well-suited. Additionally programs 108 can include a career ranker 114, a career info consolidator 116, and other programs—such as an operating system and/or assorted application programs. Programs 108 can be executed on processor(s) 104. It will also be noted that some of the programs may be associated with one another, or may be subsets of one another. For example, career info consolidator 116 could be a part of career ranker 114.

Computer-readable media 106 can also include data 118. For example, as illustrated in FIG. 1, data 118 residing on computer-readable media 106 can include user profiles 120, poster information 122, templates 124, career files 126 and other data 128 (including intermediate and final data created through use of one or more of programs 108).

Any of programs 108 and data 118 can reside wholly or partially on any of a variety of media types found in computer-readable media 106. For example, portions of resource career ranker 114 can reside at different times in random access memory (RAM), read only memory (ROM), optical storage discs (such as CDs and DVDs), floppy disks, optical devices, flash devices, etc.

A system bus 130 can couple one or more of the processor(s) 104, I/O devices 102 and computer-readable media 106 to each other. System bus 130 can include one or more of any of several types of bus structures, including a memory bus or memory controller, a peripheral bus, an accelerated graphics port, and a processor or local bus using any of a variety of bus architectures. By way of example, such architectures can include a peripheral component interconnects (PCI) bus also known as a mezzanine bus, and so on.

While a particular example architecture is illustrated in FIG. 1, it should be understood that other suitable architectures may also be used, and that implementations herein are not limited to any particular architecture.

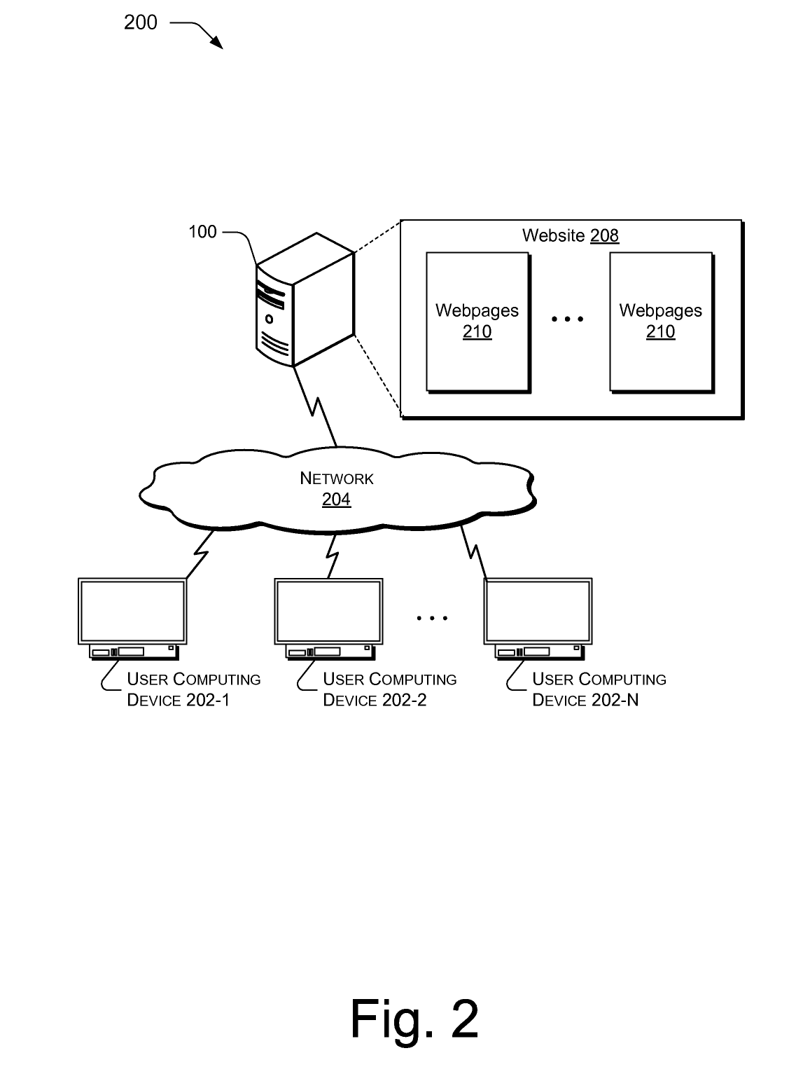

FIG. 2 illustrates one example of a system 200 for implementing career recognition and development. System 200 includes a plurality of user computing devices 202 in communication with computing device 100 and possibly with each other, such as via a network 204. Network 204 may include one or more networks, including the Internet, phone networks, etc.

In one possible implementation, computing device 100 can receive user data such as user profiles 120. It will be understood that computing device 100 is an example, and different implementations may be used, including the use of various computing devices/servers, and the use of “cloud” based infrastructures. In some implementations, computing device 100 exists as a part of a data center, server farm, or the like.

In some implementations, computing device 100 also hosts a website 208 for facilitating career recognition and development for users at user computing devices 202. Information, data, programs, commands, etc. from website 208 may be included in webpages 210 accessible by the user computing devices 202 over network 204, such as via web browsers, or the like. In other implementations, however, computing device 100 is separate from a web-hosting computing device, such as a web server (not shown) that hosts website 208.

System 200 can include any number of computing devices 100 and/or user computing devices 202. For example, in one implementation, network 204 is the Internet, and the system 200 includes numerous servers, personal computers (PCs), workstations, terminals, mobile computing devices and other computing devices spread throughout the world as computing devices 100 and user computing devices 202. Alternatively, in another possible implementation, system 200 can include just a single computing device 100 in communication with a limited number of user computing devices 202 via a LAN (local area network) or a WAN (wide area network), such as within a single company, or the like. In some implementations, user computing devices 202 are personal computers, workstations, terminals, mobile computing devices, such as cell phones, smartphones, laptops, tablets, or other portable computing devices having data processing capability, etc.

User computing devices 202 can be coupled to each other and/or to the computing device 100 in various combinations through wired and/or wireless networks, including a LAN, WAN or any other networking technology known in the art. In addition, computing device 100 may be a number of computing devices spread over network 204 in communication with each other, and each carrying out parallel or separate functions. Furthermore, while a particular example architecture is illustrated in FIG. 2, it should be understood that other suitable architectures may also be used, and that implementations herein are not limited to any particular architecture.

### Example Webpage Displaying Poster's Information

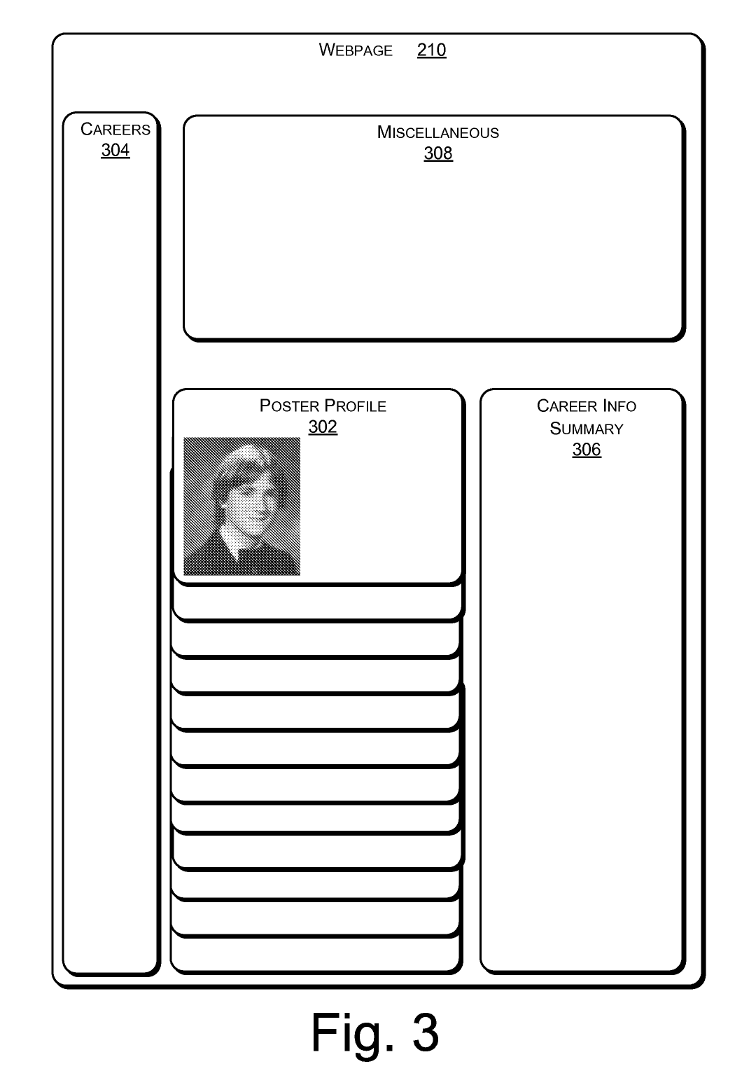

FIG. 3 illustrates an example of webpage 210 on which users and posters can interact with career information, including poster information 122, associated with website 208. Webpage 210 can be used to disseminate career information to a variety of individuals curious about possible jobs/careers, including students at all levels trying to figure out what careers might be interesting, workers contemplating a career change and individuals established in their existing careers looking for advice on how to get ahead.

In one possible implementation, webpage 210 can show users how to prepare for a given career by providing a variety of tips (such as detailing what educations and backgrounds are common for given careers, etc.) In one possible embodiment, website 208 includes the same kind of information and recommendations that a user might normally get from relatives or mentors in a given career or business area, except on website 208 this information can come from a variety of sources including one or more posters and/or one or more users that the user may not know personally.

In one possible embodiment, posters can contribute information to website 208 by entering poster information 122 through website 210. Posters can be people from industry groups, government agencies, target companies or employers, etc., who want to promote available careers and/or their organizations. Posters can also be volunteers or individuals, such as those found through crowdsourcing (i.e. visitors to website 208 who post information there). Posters may post anonymously, or they can include their names. Additionally, possible tie-ins can be made to the posters' existing profiles and personal information on social networking sites like LINKEDIN, FACEBOOK, etc. In one implementation, such tie-ins can be used to decrease a sign-in burden on posters wanting to contribute content to website 208.

Poster information 122 can be used to create a poster profile 302 associated with the poster. The poster profile 302 can include various information about the poster and the career the poster is associated with. In one possible implementation, poster profiles 302 can be standardized, such as by using a template like standardized template 124, to enable users viewing several profiles 302 to quickly and easily make meaningful comparisons. In one possible implementation template 124 can be the same for every career viewed by a user. Alternately, users may decide what information from the available universe of poster information 122 they would like presented in poster profiles 302, and in what order or format they would like it to be presented. Information that might be included in a poster profile 302 can include, among other things: Job Title; Field of work; Degree type (engineering, business, accounting, etc.); Job location; Ability to telecommute; Schools, Colleges, and Universities attended by poster; Industry of employer; Name of employer; Work atmosphere; Type of employer (government, private, non profit etc.); Years of employment; Job Satisfaction ; Fun factor—how much fun the poster has at work; Stress level; Respect/prestige level (how much respect is attributed by others to the career); Fungibility (does this career dead end, or can it lead to other careers); What cool stuff does this career teach; Is there a steady job progression in the career; Is it possible to maintain a work life balance in this career; Turnover—how long do most people stay in this line of work; Does this career involve management duties to get promotions; Yearly salary; How quickly does salary rise; Job security; How many years does it take to become an expert in this career (ex how many years do you have to work at this before you can start your own business, etc.); Recommend this job to others (Y/N); Amount of interaction with people required; Amount of creativity required; Outside or inside job; Amount of domestic travel; Amount of international travel; Use of knowledge learned in college; Pension program; Years to retire with pension; Weeks of sick leave; Weeks of vacation; Special Perks of the career; Description of daily work; What does the poster like about the career; What does the poster dislike about the career; What the poster wishes he would have done to prepare for this career; What was something the poster did that uniquely prepared him for this career; Alternate line of work (the so called “if you could do it all again” question), Career prerequisites (i.e. what types of education, training, connections, etc., are necessary to get a look from employers in this field); Who are the best employers in the field?; What kinds of things are needed to get promoted?; Social attractiveness of career (e.g., are other people, such as those of the opposite sex, impressed by your career?); Proposed reading list to get aspirants up to speed or give them an idea of what this career is all about (including one or more websites, magazines, training programs, and/or books), happiness of poster in the career, etc.

In addition to the above, posters can also blog about their jobs and careers as frequently as they like. This can include describing what is happening on a business trip and/or during a challenging or exciting period at work, posting answers to questions from users, etc. Posters can also host web chats to interact with users and answer questions. Such activity can make posters' profiles a living diary, allowing interaction between posters and users, and in certain cases between users themselves. Posters can also point out common misconceptions about their careers and employers, and post pictures and videos associated with their jobs (office pictures, travel pictures, etc.). Posters can also include suggested courses that others interested in a career might want to look at to get a better feel for the profession, and various tricks of the trade that users might find of interest.

It will be understood that in the information noted above, posters may give comments regarding both careers and individual jobs within careers.

In one possible implementation, a user interacting with webpage 210 can query for a given career, or choose a career from a list of possible careers 304. Once a career is selected, poster profiles 302 associated with the career can be presented to the user.

In one implementation, posters themselves may identify one or more careers to be associated with their poster information 122. Alternately, career matcher 112 may crawl information in the poster information 122 to surmise what career(s) the poster information 122 is associated with.

In one implementation, career files 126 can be created by examining poster information 122 associated with various careers. For example, if an attribute is widely found in poster information 122 associated with a given career, that attribute can be placed in a career file 126 associated with the career. Similarly, averaged information regarding attributes found in poster information 122 associated with a career can be placed in a career file 126 associated with the career. In such a way a career file 126 can be built including meaningful information associated with the career.

In one implementation the user can specify the number of profiles 302 to be presented, along with the type of poster profiles 302 to be presented. For example, a user may only want to see the most active poster profiles 302 (i.e. ones in which posters actively provide updates), the most highly rated poster profiles 302 (such as those highly rated by users), profiles 302 provided by posters having shared interests or backgrounds with the user (i.e. posters with a shared nationality, alma mater, cultural background, same hometown, etc. of the user), etc.

A career info summary 306 can be presented to the user based on the poster profiles 302. In one implementation this can be done by career info consolidator 116. For example, a range of salaries and/or an average of salaries collected from the poster profiles 302 can be presented, as can other ranges and averages based on the poster profiles 302, like the average job satisfaction of the career, the average amount of travel required in the career, etc. Moreover, comparisons to other careers can be included in career info summary 306, including how the given career ranks against other careers on bases like job satisfaction, happiness, salary, available positions, etc. Additionally, related careers and/or other careers that that may be of interest to the user can be suggested.

Career info summary 306 can be aggregated from all poster responses, or be limited to defined subsets. For instance, in one possible implementation, only the top 20% of posters who have commented on the career will have their results included in the aggregated information found in the summary 306.

Moreover, in another possible implementation, the contents of career info summary 306 can vary. For example, career info summary 306 can be preset to include information such as recommended education, salary ranges, job satisfaction, etc. Alternately, the contents of career info summary 306 can be set by users themselves. This can include active selection where users affirmatively choose what information they want to see in the career info summary 306, along with reactive selection where career info summary 306 evolves with the users' interactions with website 208 and/or other browsing history of the users. For instance if the user interacts frequently with career information regarding travel requirements, then travel requirements can be included in career info summary 306.

In one implementation, summary information regarding several career areas can be displayed. For example, information posted by numerous dentists can be used to derive meaningful inferences about the profession of dentistry, including things such as average job satisfaction, salary, and feelings of job security, etc., among dentists. Differences between dentists (i.e. those working in private practice, corporations, government agencies, research institutions, and various specializations, etc.) can also be discerned from this information and be used to draw a wide range of meaningful conclusions about the profession. This can be presented to a user alongside similar summaries of other careers.

By deriving and presenting average qualities and quantities of career information in this manner, information can be presented to users allowing them to meaningfully compare different career paths. For example, users can quickly compare how well-compensated, lawyers are compared to dentists and see if engineers enjoy a higher job satisfaction than nurses.

More information can be presented to the user in miscellaneous information 308, including trending careers, hot careers, news, or other information of interest, etc. Additionally, current job openings may be presented to users in miscellaneous information 308. This can include available jobs in a poster's or user's company, and/or jobs at a poster's or user's location, and/or jobs in a given career area of interest to a user, etc. In one possible implementation, such job announcements can originate at third party job listing sites such as LINKEDIN, etc.

Alternately, or additionally, a “heat map” can be presented showing a plurality of careers graphically with popular careers being shown in different colors and/or different sizes than careers that are less popular (i.e. careers not being viewed as much as others on website 208, or that aren't being liked by users as much on website 208 as other careers). Furthermore, careers attractive to various age groups of users, genders of users, nationalities of users, etc., as discerned, for example, by browsing patterns of users on website 208, may be presented to users.

In one implementation, at least some of the information presented on webpage 210 can be customized for a user, either by accepting user input, or by referring to a user's profile 120 and/or a user's browsing history.

Further, in one possible embodiment, users of website 208 can rate a poster's comments, such that posters with more positive ratings can be rated higher and given a more prominent placement on webpage 210. For example, a highly rated poster in a career category (for example, the highest rated poster in the tax attorney category) could have his poster profile 302 placed at the top of a list of poster profiles 302 presented to a user looking in the tax attorney category. Rankings in this fashion may be updated periodically or continuously.

New posters to website 208 may also be identified/indicated, making it easier for users to find them, since such posters might not have been around long enough to be rated very highly yet.

Additionally, careers may be ranked on the bases of various attributes such as happiness, salary, “sexiness,” etc., given posters' evaluations of their jobs and careers. This may include rankings of the most desirable or miserable jobs and careers. Rankings in this fashion may be updated periodically or continuously and may be created by career ranker 114.

Website 208 may also ask users what they want to know more about, such as what attributes of a job/career are most important to them. Information gleaned from such questioning may be used to add new attributes to template 124 and/or order the items in template 124 with the most interesting items being displayed at the top of a poster profile 302, etc.

In one possible implementation, posters may be given various titles. For example, titles may be conferred for humor in their posts, quality of their posts, variety of their posts, frequency of their posts, etc. Posters may additionally get titles based on how many users like their posts, etc.

### Example Career Recommendation

In one possible implementation, a user can interact with website 208 and populate a corresponding user profile 120 with information about the user's personality, including the user's characteristics and traits. For example, a user may be introverted, extroverted, creative, logical, enjoy interacting with people, enjoy working in teams, prefer working alone, enjoy teaching others, enjoy being a leader, prefer being a follower, appreciate learning new things, want to master a subject without having to continually learn, enjoy traveling, prefer staying in one place, value working indoors, prefer working outdoors, desire to be a generalist, desire to be a specialist, etc.

User profile 120 can also be populated with skills and competencies of the user, including the user's educational background, employment history, professional certifications, professional achievements, hobbies, talents, skills, etc. Further, user profile 120 can include other information of interest such as languages spoken, places lived during the user's lifetime, political affiliation, family background, cultural background, national background, interests, dislikes, aspirations and anything else that might give some insight into what the user might enjoy, might be able to do, etc. In one aspect, user profile 120 can include similar information to that found in poster information 122.

In one implementation, the user can help populate user profile 120 by answering a questionnaire. The questionnaire can, for example, be generated by questionnaire generator 110 and can attempt to collect personal information such as that described above. Additionally, information about the user can be derived from online sources, such as by examining the user's activity on and/or examining references to the user on social media and networking websites. In one possible aspect, the user can also be allowed to populate their corresponding user profile 120 on website 208 by importing information from other platforms with which the user might be involved, including FACEBOOK and LINKEDIN.

Additionally, in one possible embodiment, a user can complete a detailed personality test to quantify the user's personality into an established rating system. Personality tests and personality rating systems can include any known in the art (including Myers-Briggs, etc.), as well as any new methods which might be developed using information gleaned from user profiles 120 and poster information 122 entered into site 208. In one possible aspect, 360 degree feedback can be used to sharpen personality test results. For example, once a user interacts with a personality test or rating system, people associated with the user (friends, family, coworkers, bosses, subordinates, clients, etc.) can be asked to take the questionnaire and/or interact with the rating system on the user's behalf This can lend an interesting perspective of the user, i.e. it can let the user see how he is viewed by others around him.

In one possible implementation, users can go to a third party website and take a personality test. The results of this test can then be imported into their user profiles 120. A similar procedure can be followed by posters in order to augment personality information associated with their poster information 122. The inclusion of such personality information in user profiles 120 and poster information 122 can allow for sharper matching of users and posters (and users and careers).

In one possible embodiment, to arrive at career recommendations, career matcher 112 can sift through the various poster information 122 and career information available to it (including career files 126), and look for correlations between user's profile 120 and various available careers. Such correlations can be used to point the user towards various types of careers the user might be interested in and/or be suitable for.

For example, a user with a distinctive education history might be recommended careers in which posters have indicated the same or similar education histories as being useful, prerequisite, desirable, etc. Similarly, career matcher 112 can look to see if the unique mix of attributes for a user (including personality traits, education, skills, etc.) enjoys a correlation with the attributes indicated as being helpful by posters for one or more careers.

With this jumping off point, the user can then do more research and look into the various careers (recommended or otherwise) to see if posters associated with those careers are happy, etc. For example, if a user viewing various careers suggested by career matcher 112 is looking only at “salary”, the user may find a career that pays extremely well; however, there may be posters in that career that are miserable with their jobs and would not recommend such a career.

In one possible embodiment, users can be referred to posters in areas of interest to the users. In one aspect this can be done on bases of commonality—for example, posters and users that went to the same school, worked at the same company, come from the same geographic area, etc., can be connected.

Additionally, careers may be presented based on demand. For example, if there are not enough engineers in the oil business and/or it appears that a shortage may be on the horizon, this may be presented to users. For instance, sections such as ‘in-demand careers’, ‘future in-demand careers’, etc., may be presented to users on webpage 210.

Careers may also be ranked and presented based on their environmental friendliness or other such variables that might be of interest to users. Moreover, careers may also be ranked on how resistant or susceptible they are to outsourcing. Additionally, careers may be ranked on how difficult they are to carry on alone as a solo entrepreneur or in a small business (i.e., could be of interest to job seekers wishing one day to start their own business and/or begin working from home).

Users may also create their own webpages 210, and refer to careers, jobs, companies, posters, etc., that they “like.” Users' pages 210 may be similar to those found on social networking sites such as FACEBOOK, LINKEDIN, etc., and may be linked to them.

In another possible implementation, posters and/or users can be members of groups, such as common interest groups, common background groups, etc. For example, graduates of a certain university may be included in a group. Similarly, people who currently work and/or previously worked at a company may be included in a group. Membership in groups can entitle members to various updates, such as new information that might be of interest to them. For instance, if something changes with a university, members of the university group can receive an update informing them of the change.

In one possible embodiment, posters may also have a mentoring section where they give advice on how to get into and/or get ahead in a given career. This may include stories from their past, lessons learned, and mistakes they have made.

In another possible implementation, career progression information provided by posters can be collected and processed to provide users information regarding possible future careers. Stated another way, information from posters can be used to provide users advice regarding where the users might want to go next given their individual backgrounds.

For instance, if it turns out that a degree in mechanical engineering is a common and/or valued background for orthodontists, a career in orthodontics can be recommended to mechanical engineers looking for a new career. Extrapolations like this can be formed by examining career information (including job histories, educational information, personality information, life experience information and so on as found in user profiles 120 and poster information 122) from a variety of posters and/or users.

In another possible implementation, if certain careers are associated with practitioners who are outgoing and like working outdoors, these careers can be recommended to users sharing such interests (as noted, for example, in the users' profiles 120 or the user's interactions with website 208).

Similarly, a variety of different aspects of a career taken from poster information 122—including aggregate information gleaned from multiple posters in a career area—and information from other sources, can be viewed alongside a user's profile 120 to see if there is any match. Correlation need not be 100% for a match to be surmised. Instead a smaller correlation may be enough to instigate the furnishing of a recommendation to a user. In one implementation, this can be done by career matcher 112.

In one implementation, users can be given such matching information implicitly—i.e. a recommendation can be made to a user with a quantifier such as “the career of small animal veterinarian has a 54% match with your profile”.

Further, it may be learned that certain areas, such as educational background, and job satisfaction (for example) have highlighted significance, so if there is agreement between these areas in a user's profile 120 and a career, a recommendation can be made. Areas of highlighted significance can be universal for all users, or they may vary among users.

Alternately, or additionally, in one possible implementation users (for example without user profiles 120, or with inadequate user profiles 120) can be asked a few questions about themselves, and the answers to these questions can be compared to existing job/career information to see where possible matches might exist and matches can be presented to users. In one possible embodiment, users can be presented with percent match information to give them an idea of how accurate matches might be. The questions asked can vary, and can range from only a few questions to many questions. In one implementation, users themselves can determine how many questions they answer. For example, users can be shown possible career matches dynamically, and if they aren't pleased with the matches they are getting, they can continue to answer questions to improve the accuracy of the matches.

For instance, a user can be asked a set of 5 questions which may result in several matches with the best having a stated accuracy of, for example, 43%. The user can then opt to answer more questions and dynamically receive new career matches that may increase the match accuracy, such that the user can continue answering questions until he receives matches above a certain threshold, such as 80% or so. The questions can be preset, or they can be tailored based on a user's stated preferences (i.e. if a user states that compensation is most important for him, then questions involving pay, benefits and other elements of compensation might be included). Matches can be presented on any of the bases discussed herein.

Additionally, once new careers have been recommended, available jobs in those careers, or interesting information, such as career skill improvement resources regarding those careers (including things like offers for books, courses, videos, test preparation information, etc.) can be presented on webpage 210 or otherwise communicated to the users. Similarly, when users browse career areas on their own, available jobs in those career areas, as well as information regarding those careers (including offers to purchase information like books, videos, etc.) can be actively presented to the users.

In another possible implementation, organizations looking to promote career paths can also post career information. For example, due to a wave of retirements, the oilfield services industry is presently suffering from a shortage of engineers. Through a “Featured Careers” section, such as in miscellaneous 308, or communications communicated to users with applicable backgrounds, career paths in oil field services can be promoted. In this way companies and industries can raise awareness among suitable candidates.

A variety of goods and services can also be sold to users and posters. For example, users looking at poster's posts and/or career profiles may encounter books and other learning materials recommended by posters as being helpful background resources for a given career. In one possible aspect, for a commission or other consideration, users can be linked directly to sellers of such books and materials.

In other instances, users might discover a need for continuing education in order to enter a new career. For a commission or other consideration, users can be directed to organizations, including online and other providers offering such educations. Similarly, for a commission or other consideration users can be directed to preparation courses for entrance exams, like the LSAT, GMAT, GRE, etc.

Similarly, various self-improvement courses, including leadership camps, negotiation courses, finance courses, etiquette courses, contract courses, and investment courses can be offered to users and posters. These courses can be recommended by posters, or they can be recommended based on a user's profile 120. In one possible implementation, users can rate all the products and services recommended to them, with these ratings being displayed in poster profiles 302 and/or future recommendations to other users.

In another possible implementation, users can be allowed to quantify their personalities and/or skills. In some instances this can be gamified, allowing users to write code or solve certain problems under a variety of game scenarios to demonstrate their cognitive abilities. Gamification can also be employed to train users to improve various abilities, with improvements being reflected in increased scores in their user profiles 120. These increased scores can then be used to help employers locate the best candidates for their organizations.

Moreover, information regarding users can also be gleaned by crawling various web pages and services associated with any domain knowledge users may profess to have. In this way, the professed domain expertise of users can be better gauged by, for example, reviewing how frequently they contribute, how well their contributions are received by judges or other users, gauging how prestigious the entities to which they contribute are, noting how often their contributions or publications are cited by others, noting how often they receive distinctions (such as awards) or are nominated for distinctions, etc. Such information can then be used to formulate one or more scores assessing aspects of a user's profile 120 including things such as the user's domain knowledge, leadership qualities, ability to work in teams, prestige in their field, etc. In one possible implementation, information of this type can be used to create a domain rating for the user.

For example, if a user professes to be a web designer, sites like DRIBBLE.COM can be examined for user activity, such as contributions, posts, etc. Likewise, if a user is a developer, sites like GITHUB.COM and/or STACKOVERFLOW.COM can be examined for user activity. Moreover, journals and other publications like RESEARCHGATE.COM can be examined. For example, psychology journals can be examined for users professing a domain expertise in psychology and law journals can be examined for users professing legal expertise. Similarly, various information associated with professional and other conventions can be examined for user participation, as can media contributions such as TWITTER comments associated with the user. Moreover awards in the domain can be examined to see if the user has been a recipient, has been nominated, etc.

Similarly patent databases can be viewed to see if the user is listed as an inventor on any issued patents or published applications. These patent documents can then be analyzed to see how often they have been cited by Examiners at various patent offices, have been the object of litigation, etc.

In one implementation, a user can improve scores associated with some aspects of his profile 120 if he exhibits positive behaviors on sites associated with his domain knowledge (i.e. he posts frequently on such sites, is well liked by other posters and users on such sites, his contributions are accepted by prestigious sites, etc.).

In another possible implementation, the user's profile 120—including the scores determined using the interactions noted above, can be furnished to prospective employers and/or used to determine how qualified a user might be for a certain position.

In one possible embodiment, users can be provided with on-demand recommendations for new careers that might be suitable for them based on their profiles 120.

In another possible implementation, data on various careers (including summaries of careers, data on job trends and other information regarding careers) can be sold to interested parties such as industry and human resource organizations.

Website 208 can also help companies filter and find the best candidates for open positions by providing one or more quantifiable metrics to measure job suitability of users for given jobs/careers. In another possible implementation, website 208 can sort users based on compatibility with a given career or job based on variables and or characteristics of significance to a potential employer.

### Example Methods

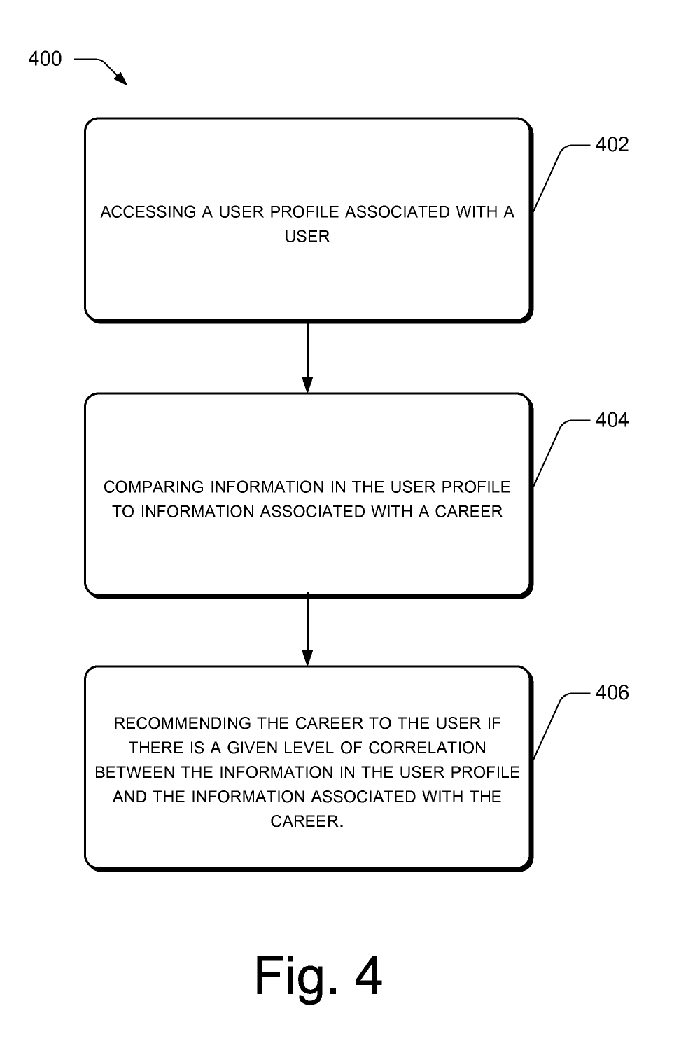

FIGS. 4-6 illustrate example methods for implementing aspects of career recognition and development. The methods are illustrated as a collection of blocks in a logical flow graph representing a sequence of operations that can be implemented in hardware, software, firmware, various logic or any combination thereof. The order in which the methods are described is not intended to be construed as a limitation, and any number of the described method blocks can be combined in any order to implement the methods, or alternate methods. Additionally, individual blocks may be deleted from the methods without departing from the spirit and scope of the subject matter described therein. In the context of software, the blocks can represent computer instructions that, when executed by one or more processors, perform the recited operations. Moreover, for discussion purposes, and not purposes of limitation, selected aspects of the methods may described with reference to elements shown in FIGS. 1-3.

### Example Method I

FIG. 4 illustrates an example method 400 for implementing career recognition and development.

At block 402, a user profile associated with a user is accessed. In one implementation, the user profiles can be user profiles 120. Accessing can occur when existing information in the user profiles is accessed. Alternately, or additionally, it can occur when further information regarding a user is located, such as by accepting personality test results from third parties, crawling internet websites for information associated with a given user, accepting questionnaire results from the user, etc.

At block 404 information in the user profile is compared to information associated with a career, such as information that might be found in career files 126 and/or poster information 122. In one implementation, a subset of information in the user profile can be compared to the information associated with a career. For example, in one possible implementation a user that is primarily interested in careers matching a subset of his attributes and interests, can restrict his search to such attributes in associated careers (for instance perhaps he wants to find careers compatible with outside work and which require minimal interaction with people).

At block 406, a career can be recommended to the user if there is a given level of correlation between the information in the user profile and the information associated with the career. In one implementation the given level of correlation can be set by the user. In another implementation, a list of the best fits can be given to the user, such as a top 10 or top 5 listing of careers that best match some or all of the user's profile.

### Example Method II

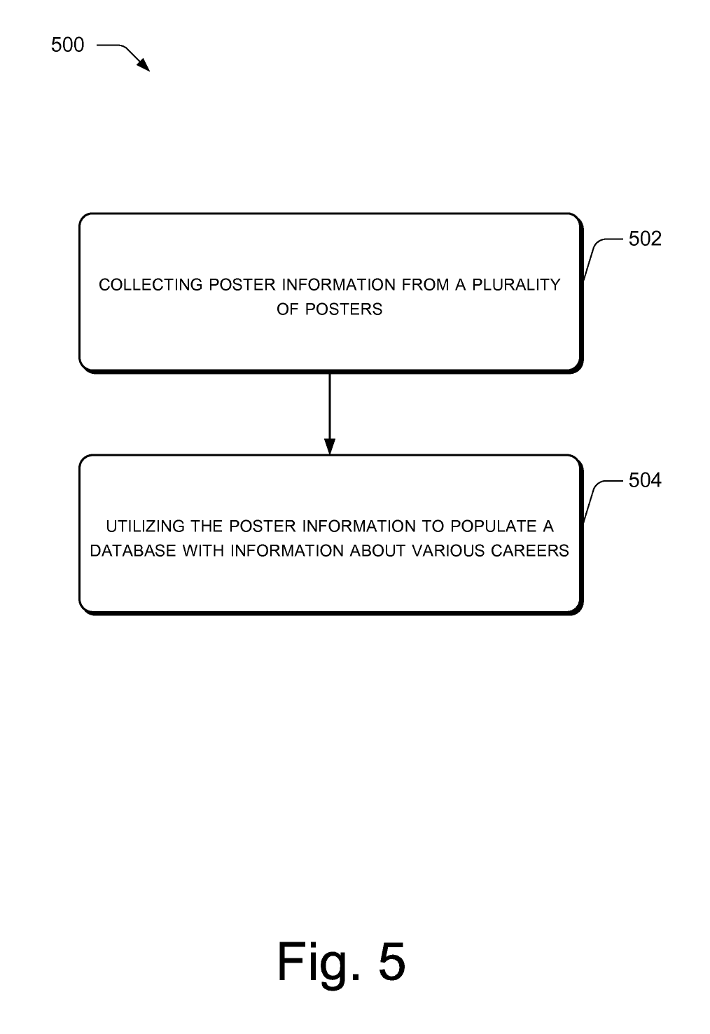

FIG. 5 illustrates an example method 500 for implementing career recognition and development.

At block 502, poster information, such as poster information 122, is collected from a plurality of posters. In one possible implementation, this can be accomplished by allowing posters to interact with website 208 and enter information about a career they may currently have or they may have some expertise about. In one possible aspect this can be done through crowdsourcing over the Internet.

At block 504, poster information is used to populate a database, such as career files 126 with information about various careers. The database can be accessible to users such that they can learn about a wide variety of careers commented on by the posters.

### Example Method III

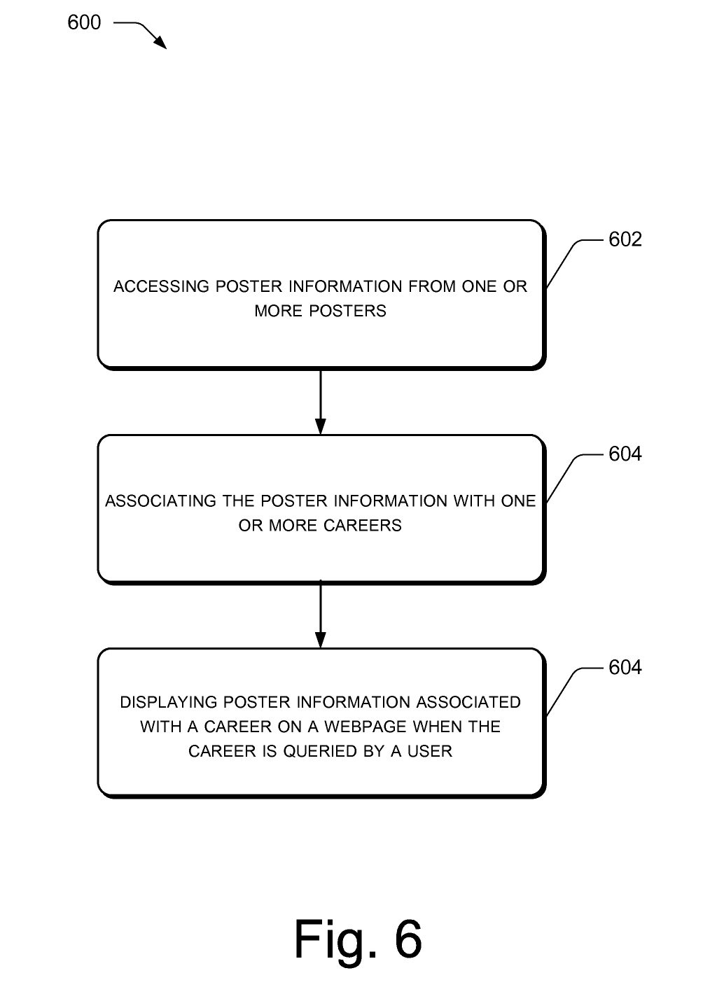

FIG. 6 illustrates an example method 600 for implementing career recognition and development.

At block 602, poster information, such as poster information 122, is accessed from one or more posters. For example, in one possible implementation, posters can enter information into poster information 122 and career files 126. This information can include a variety of information regarding various careers, such as prerequistites for getting into the careers or being successful in them, the types of people that do well in such careers, the kinds of compensation which can be expected in the careers, etc.

At block 604, the poster information is associated with one or more careers. In one implementation, the poster information can be organized into one or more career files, such as career files 126. For example, information entered by posters regarding the career of civil engineering can be placed in a career file associated with civil engineering. Similarly information entered by posters on the field of family law can be placed in a career file associated with family law.

At block 606, when a given career is queried by a user, poster information associated with the career can be displayed on a webpage, such as webpage 210. For instance, if a user wants to know about the field of tax law, the user can submit an associated query to the webpage and all or some the poster information from posters associated with careers in tax law can be presented to the user. In one implementation the poster information can be collected by career info consolidator 116. Poster information can be displayed as individual posts (i.e. some or all of the posts created by posters who have posted information about tax law) and/or as a summary, such as career info summary 306.

### CONCLUSION

The described example implementations are intended to be primarily examples and are not intended to limit the scope of the appended claims.

Moreover, the word “example” is used herein to mean serving as an example, instance, or illustration. Any aspect or design described herein as “example” is not necessarily to be construed as preferred or advantageous over other aspects or designs. Rather, use of the word example is intended to present concepts and techniques in a concrete fashion. The term “techniques”, for instance, may refer to one or more devices, apparatuses, systems, methods, articles of manufacture, and/or computer-readable instructions as indicated by the context described herein.

Additionally, although only a few examples have been described in detail above, those skilled in the art will readily appreciate that many modifications are possible in the examples. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

1. A method of distributing career information to a user computing device over a network comprising:
providing the user computing device access to a website;
accessing a user profile associated with a user associated with the user computing device;
comparing information in the user profile to information associated with a career; and
generating and presenting a recommendation of the career to the user if there is a given level of correlation between the information in the user profile and the information associated with the career.

2. The method of claim 1, wherein accessing a user profile includes one or more of:
accepting personality test results associated with the user from a third party source;
registering browsing activity on the user computing device associated with the user;
accepting questionnaire responses from the user;
accepting profile information input by the user.

3. The method of claim 1, further comprising accepting via the website poster information from a plurality of posters regarding the career and including at least some of the accepted information in the information associated with the career.

4. The method of claim 3, further comprising:
recommending one or more posters to the user that share commonalities with the user.

5. The method of claim 3, further comprising:
allowing the user to interact with one or more posters on webpages associated with the posters.

6. The method of claim 3, further comprising:
allowing the user to rate one or more of the posters.

7. The method of claim 1, further comprising allowing the user to set the given level of correlation.

8. A computer-readable storage medium having a set of computer-readable instructions residing thereon that, when executed, direct a processor to initiate acts comprising:
collecting at a website poster information from a plurality of posters via a plurality of user computing devices over a network; and
utilizing the poster information to populate a database with information about various careers.

9. The computer-readable medium of claim 8 having a set of computer-readable instructions that, when executed, perform acts further comprising:
allowing a user to interact with the database over the network via a user computing device to learn about one or more of the various careers.

10. The computer-readable medium of claim 9 having a set of computer-readable instructions that, when executed, perform acts further comprising:
allowing the user to rate one or more of the plurality of posters.

11. The computer-readable medium of claim 8 having a set of computer-readable instructions that, when executed, perform acts further comprising:
accessing a user profile associated with a user; and
comparing at least some information in the user profile with at least some of information about the various careers in the database to recommend at least one of the various careers to the user.

12. The computer-readable medium of claim 11 having a set of computer-readable instructions that, when executed, perform acts further comprising:
populating at least some of the user profile with personality test results associated with the user.

13. The computer-readable medium of claim 11 having a set of computer-readable instructions that, when executed, perform acts further comprising:
populating at least some of the user profile with information about the user found on one or more webpages.

14. The computer-readable medium of claim 11 having a set of computer-readable instructions that, when executed, perform acts further comprising:
offering the user a new possible new career path by extrapolating from career progression information in the poster information one or more career skill improvement resources.

15. A computer-readable storage medium having a set of computer-readable instructions residing thereon that, when executed, direct a processor to initiate acts comprising:
accessing poster information from one or more posters;
associating the poster information with one or more careers;
displaying poster information associated with a career on a webpage associated with a user when the career is queried by the user.

16. The computer-readable medium of claim 15 having a set of computer-readable instructions that, when executed, perform acts further comprising:
allowing a poster to update the poster information.

17. The computer-readable medium of claim 15 having a set of computer-readable instructions that, when executed, perform acts further comprising:
associating the poster information with one or more careers in career files.

18. The computer-readable medium of claim 15 having a set of computer-readable instructions that, when executed, perform acts further comprising:
displaying a summary of one or more aspects of the poster information from various posters associated with a given career.

19. The computer-readable medium of claim 15 having a set of computer-readable instructions that, when executed, perform acts further comprising:
allowing a user to rate a poster based on the poster information of the poster.

20. The computer-readable medium of claim 15 having a set of computer-readable instructions that, when executed, perform acts further comprising:
customizing information presented on the webpage associated with the user based on one or more of:
input from the user;
information from a user profile associated with the user;
a browsing history associated with the user.
